(19) United States
(12) Patent Application Publication
(10) Pub. No.: US 2025/0173474 A1
(43) Pub. Date: May 29, 2025

(54) PRIVACY-PRESERVED METHOD FOR CONSTRUCTING AGGREGATE THERMAL DYNAMIC MODEL OF BUILDINGS

(71) Applicant: SOUTHEAST UNIVERSITY, Nanjing (CN)

(72) Inventors: Shuai Lu, Nanjing (CN); Zeyin Hou, Nanjing (CN); Wei Gu, Nanjing (CN); Yijun Xu, Nanjing (CN); Jiayi Ding, Nanjing (CN)

(21) Appl. No.: 18/890,041

(22) Filed: Sep. 19, 2024

Related U.S. Application Data
(63) Continuation of application No. PCT/CN2023/136282, filed on Dec. 5, 2023.

(30) Foreign Application Priority Data
Nov. 28, 2023 (CN) 202311613700.3

(51) Int. Cl. G06F 30/13

(52) U.S. Cl. CPC G06F 30/13

(57) ABSTRACT

Disclosed is a privacy-preserved method for constructing an aggregate thermal dynamic model of buildings, including the steps of: establishing a thermal dynamic model of one building region, and establishing an aggregate thermal dynamic model of buildings based on an aggregation equation; performing parameter estimation using a least square method based on a measurement equation, introducing a regular term to solve a sparsity problem, and obtaining a parameter estimation model in a compact form for the aggregate thermal dynamic model of buildings; and establishing a privacy-preserved parameter estimation method for the aggregate thermal dynamic model of buildings. Based on the technique, the aggregate modeling is performed on numerous buildings by a building load aggregator to participate in the operation and control of an energy system while preserving privacy of building users, promoting the mining of thermal inertia of buildings and enhancing the flexibility of operation and regulation of a power system.

### CROSS-REFERENCE TO RELATED APPLICATIONS

This application is a continuation of PCT/CN2023/136282, filed on Dec. 5, 2023 and claims priority of Chinese Patent Application No. 202311613700.3, filed on Nov. 28, 2023, the entire contents of which are incorporated herein by reference.

### TECHNICAL FIELD

The present disclosure belongs to the technical field of privacy preservation and demand-side response in power systems and mainly relates to a privacy-preserved method for constructing an aggregate thermal dynamic model of buildings.

### BACKGROUND

The power system is undergoing significant changes as intermittent renewable energy increases in proportion, and it needs more flexible resources to support its safe and economical operation. The thermal inertia inherent to buildings provides considerable flexibility for heating and cooling, which is identified as a promising demand response resource, and the concept of utilizing the thermal inertia of buildings to serve for power system operation and control has attracted extensive attention from both the academic and engineering communities.

However, there are difficulties in putting building flexibility resources into practical applications. On the one hand, due to the large number of buildings, direct information interaction between the energy system and numerous building users imposes a huge burden on computation and communication; on the other hand, the current methods for mining building flexibility lack the means to preserve the user's privacy information. Thus, there is a risk of leaking the user's privacy information.

### SUMMARY

In response to the problems existing in the prior art, the present disclosure provides a privacy-preserved method for constructing an aggregate thermal dynamic model of buildings, including the steps of: establishing a thermal dynamic model of one building region, and further establishing an aggregate thermal dynamic model of buildings; performing parameter estimation using the least square method, introducing a regular term to solve a sparsity problem, and obtaining a parameter estimation model in a compact form; establishing a privacy-preserved parameter estimation method for the aggregate thermal dynamic model of buildings. Based on the technique, the aggregate modeling is performed on numerous buildings by a building load aggregator to participate in the operation and control of an energy system while preserving the privacy of building users, promoting the mining of thermal inertia of buildings, and enhancing the flexibility of operation and regulation of a power system.

To realize the above objective, the present disclosure employs the following technical solutions: a privacy-preserved method for constructing an aggregate thermal dynamic model of buildings includes the steps of: establishing an aggregate thermal dynamic model of buildings and its corresponding parameter estimation model; according to a block coordinate descent theory, dividing the original non-convex parameter estimation problem into two convex optimization problems for iterative solution, and realizing the privacy preservation of user's information according to a transformation-based encryption method and a secure aggregation protocol (SAP).

In an improved solution of the present disclosure, the privacy-preserved method for constructing an aggregate thermal dynamic model of buildings includes the following steps:
S1, establishing an aggregate thermal dynamic model of buildings: establishing a thermal dynamic model of one building region, and establishing an aggregate thermal dynamic model of buildings based on an aggregation equation:

$${\tilde{τ}}_{i n , bc}^{t} = {\sum }_{m ∈ M ∖ \{ 0 \}} {α}_{b c}^{m} {\tilde{τ}}_{i n , bc}^{t - m} + {\sum }_{m ∈ M} {\sum }_{i ∈ K} {β}_{b c}^{m} {h}_{load , z}^{i , t - m} + {\sum }_{m ∈ M} {γ}_{b c}^{m} {τ}_{out}^{t - m} + {\sum }_{m ∈ M} {θ}_{b c}^{m} {h}_{r a d}^{t - m} + {τ}_{o cc , bc}^{t} ,$$

$$∀ t ∈ T$$

$$s . t .$$

$${\sum }_{i ∈ K} {ξ}_{b c}^{i} = 1 ,$$

$${ξ}_{b c}^{i} \geq 0 ,$$

$$∀ i ∈ K$$

where τ_{in,bc}^{˜t} represents an aggregated indoor temperature of a building cluster, h_{load,z}^{i,t-m} represents a thermal power of a sub-region i at the moment t-m, τₒᵤₜ^{t-m} represents an outdoor temperature at the moment t-m, h_{rad}^{t-m} represents a solar radiant power at the moment t-m, τ_{occ,bc}^{t} serves to depict the role of occupants' activities, ξ_{bc}ⁱ represents an aggregation coefficient of an iₜₕ building region, a set K={1, 2, . . . , K} represents various building regions, and α_{bc}^{m}, β_{bc}^{m}, γ_{bc}^{m}, and θ_{bc}^{m} represent parameters of the aggregate thermal dynamic model of buildings;
S2, establishing a parameter estimation model for the aggregate thermal dynamic model of buildings: performing parameter estimation using a least square method based on a measurement equation, and introducing a regular term to solve a sparsity problem of an aggregation coefficient, to obtain a parameter estimation model in a compact form for the aggregate thermal dynamic model of buildings:

$${min}_{ξ , α , β , γ , {τ}_{occ}} f ( ξ , α , β , γ , θ , {τ}_{occ} ) = {‖ {c}_{0} ξ - {c}_{1} ( {I}_{M} ⊗ ξ ) α - {c}_{2} β - {c}_{3} γ - {c}_{4} θ - {τ}_{occ} ‖}_{2}^{2} + λ {‖ ξ ‖}_{2}^{2}$$

$$s . t .$$

$$ξ \geq 0 ,$$

$${1}^{T} ξ = 1$$

$$where ,$$

$$ξ = {[ {ξ}_{bc}^{1} , … , {ξ}_{bc}^{K} ]}^{T} ,$$

$$α = {[ {α}_{bc}^{1} , … , {α}_{bc}^{M} ]}^{T} ,$$

$$β = {[ {β}_{bc}^{0} , … , {β}_{bc}^{M} ]}^{T} ,$$

$$γ = {[ {γ}_{bc}^{0} , … , {γ}_{bc}^{M} ]}^{T} ,$$

$$θ = {[ {θ}_{bc}^{0} , … , {θ}_{bc}^{M} ]}^{T} ,$$

$${τ}_{occ} = {[ {τ}_{occ}^{1} , … , {τ}_{occ}^{T} ]}^{T} ,$$

$${τ}_{out}^{- m} = {[ {τ}_{out}^{1 - m} , … , {τ}_{out}^{T - m} ]}^{T} ,$$

$${h}_{ra d}^{- m} = {[ {h}_{ra d}^{1 - m} , … , {h}_{ra d}^{T - m} ]}^{T} ,$$

$${h}_{load , z}^{1 - m} = ( \begin{matrix}{h}_{load , z}^{1 , 1 - m} & ⋯ & {h}_{load , z}^{K , 1 - m} \\ ⋮ & ⋱ & ⋮ \\ {h}_{load , z}^{1 , T - m} & ⋯ & {h}_{load , z}^{K , T - m}\end{matrix} ) ,$$

$${τ}_{i n , z}^{- m} = ( \begin{matrix}{τ}_{i n , z}^{1 , 1 - m} & ⋯ & {τ}_{i n , z}^{K , 1 - m} \\ ⋮ & ⋱ & ⋮ \\ {τ}_{i n , z}^{1 , T - m} & ⋯ & {τ}_{i n , z}^{K , T - m}\end{matrix} ) ,$$

$${c}_{0} = {τ}_{i n , z}^{- 0} ,$$

$${c}_{1} = [ {τ}_{i n , z}^{- 1} , … , {τ}_{i n , z}^{- M} ] ,$$

$${c}_{2} = [ {h}_{load , z}^{- 0} {1}_{K} , … , {h}_{load , z}^{- M} {1}_{K} ] ,$$

$${c}_{3} = [ {τ}_{out}^{- 0} , … , {τ}_{out}^{- M} ] ,$$

$$and$$

$${c}_{4} = [ {h}_{r ad}^{- 0} , … , {h}_{r ad}^{- M} ] ,$$

$${I}_{M}$$

represents an M dimensional I-vector, and ⊗ represents a Kronecker product; and
S3, establishing a privacy-preserved parameter estimation method for the aggregate thermal dynamic model of buildings: decomposing the parameter estimation model for the aggregate thermal dynamic model of buildings established in step S2 into two quadratic programming sub-problems, expressed by the following mathematical expressions:

$$S {P}_{I} ( ξ ) t : {min}_{α , β , γ , θ , {τ}_{occ}} f ( ξ , α , β , γ , θ , {τ}_{occ} ) ,$$

$$and$$

$$S {P}_{II} ( α ) : {min}_{ξ , β , γ , θ , {τ}_{occ}} f ( ξ , α , β , γ , θ , {τ}_{occ} )$$

$$s . t .$$

$$ξ \geq 0 ,$$

$${1}^{T} ξ = 1 ,$$

for sub-problem 1, completing a privacy-preserved calculation by a building load aggregator based on SAP, and solving the sub-problem 1 to obtain α(ξ), β(ξ), γ(ξ), θ(ξ), and τ_{occ}(ξ); for sub-problem 2, introducing a random transformation matrix by the building load aggregator, completing a privacy-preserved calculation based on SAP, and solving the sub-problem 2 to obtain ξ(α), β(α), γ(α), θ(α), and τ_{occ}(α); setting an initial value of iteration by the building load aggregator, setting an initial value of iteration by the building load aggregator, setting δ<10⁻⁶ as an iteration termination condition for a difference value 8 between objective functions of the sub-problem 1 and the sub-problem 2, and sequentially repeating the privacy-preserved calculation of the sub-problem 1 and the sub-problem 2 until the iteration converges.

In an improved solution of the present disclosure, in step S1, the thermal dynamic model of the building region is specified as:

$${τ}_{i n , z}^{t} = {\sum }_{m ∈ M ∖ \{ 0 \}} {α}_{z}^{m} {τ}_{i n , z}^{t - m} + {\sum }_{m ∈ M} {β}_{z}^{m} {h}_{load , z}^{t - m} + {\sum }_{m ∈ M} {γ}_{z}^{m} {τ}_{out}^{t - m} + {\sum }_{m ∈ M} {θ}_{z}^{m} {h}_{r a d}^{t - m} + {τ}_{occ}^{t} ,$$

$$∀ t ∈ T$$

where τ_{in,z}^{t} represents an indoor temperature, α_{z}^{m}, γ_{z}^{m}, γ_{z}^{m}, and θ_{z}^{m} represent parameters of the thermal dynamic model of the building region, and a set M={0,1, . . . , M} characterizes orders of the model; and
the aggregation equation is specified as:

$${\tilde{τ}}_{i n , bc}^{t} = {\sum }_{i ∈ K} {ξ}_{b c}^{i} {τ}_{i n , z}^{i , t} \\ ( {\sum }_{i ∈ K} {ξ}_{b c}^{i} = 1 , {ξ}_{b c}^{i} \geq 0 , ∀ i ∈ K )$$

where τ_{in,z}^{i,t} represents an indoor temperature of a building region i at a moment t.

In an improved solution of the present disclosure, the measurement equation in step S2 is specified as:

$${\sum }_{i ∈ K} {ξ}_{b c}^{i} {τ}_{i n , z}^{i ,} = {\sum }_{m ∈ M ∖ \{ 0 \}} {\sum }_{i ∈ K} {α}_{b c}^{m} {ξ}_{b c}^{i} {τ}_{i n , z}^{i , t - m} + {\sum }_{m ∈ M} {\sum }_{i ∈ K} {β}_{b c}^{m} {h}_{load , z}^{i , t - m} + {\sum }_{m ∈ M} {γ}_{b c}^{m} {τ}_{out}^{t - m} + {\sum }_{m ∈ M} {θ}_{b c}^{m} {h}_{r a d}^{t - m} + {τ}_{o cc , bc}^{t} + {ε}^{t} ,$$

$$∀ t ∈ T$$

where ε^{t} represents an independently and identically distributed Gaussian noise.

In another improved solution of the present disclosure, in step S3, the flow of a privacy-preserved calculation method for the sub-problem 1 is as follows:
S31: transferring ξᵢ by the building load aggregator to an iₜₕ building region;
S32: calculating Sᵢ^{-m} by the iₜₕ building region according to Sᵢ^{-m}=ξᵢ(τ_{in,z}^{-m})ⁱ, where (τ_{in,z}^{-m}) represents an iₜₕ column of a matrix τ_{in,z}^{-m};
S33: generating a random vector r_{i,j}^{-m} by the iₜₕ building region and sharing the same with all other building regions, collecting random vectors shared by the other building regions, and performing the following calculation:

$${\tilde{S}}_{i}^{- m} = {S}_{i}^{- m} + {\sum }_{j > i} {r}_{i , j}^{- m} - {\sum }_{j < i} {r}_{j , i}^{- m} ;$$

S34: transferring \tilde{S}ᵢ^{-m} by the iₜₕ building region to the building load aggregator;
S35: calculating c₀ξ and c₁(I_{M}⊗ξ) by the building load aggregator:

$${c}_{0} ξ = {τ}_{i n , z}^{- 0} ξ = {\sum }_{i ∈ K} {S}_{i}^{- 0} = {\sum }_{i ∈ K} {\tilde{S}}_{i}^{- 0} ,$$

$$and$$

$${c}_{1} ( {I}_{M} ⊗ ξ ) = [ {τ}_{i n , z}^{- 1} ξ , … , {τ}_{i n , z}^{- M} ξ ] = [ {\sum }_{i ∈ K} {\tilde{S}}_{i}^{- 1} , … , {\sum }_{i ∈ K} {\tilde{S}}_{i}^{- M} ] ;$$

and
S36: solving the sub-problem 1 by the building load aggregator to obtain α(ξ), β(ξ), γ(ξ), θ(ξ), and τ_{occ}(ξ).

In a further improved solution of the present disclosure, in step S3, the random transformation matrix is introduced to further transform the sub-problem 2 into:

$${min}_{\overline{ξ} , β , γ , θ , {τ}_{occ}} f ( \overline{ξ} , β , γ , θ , {τ}_{occ} ) = {‖ {\hat{τ}}_{i n , z} {W}^{T} \overline{ξ} - {c}_{2} β - {c}_{3} γ - {c}_{4} θ - {τ}_{occ} ‖}_{2}^{2} + λ {\overline{ξ}}^{T} W {W}^{T} \overline{ξ}$$

$$s . t .$$

$${W}^{T} \overline{ξ} \geq 0 ,$$

$${1}^{T} {W}^{T} \overline{ξ} = 1 ,$$

denoting \hat{τ}_{in,z}^{[i]} as an iₜₕ column of \hat{τ}_{in,z}, the information required by the building load aggregator to solve the sub-problem 2 being \hat{τ}_{in,z}W^{T}, WW^{T}, and 1^{T}W^{T}, expressed in summation forms:

$${\hat{τ}}_{i n , z} {W}^{T} = {\sum }_{i ∈ K} {{\hat{τ}}_{i n , z}^{[ i ]} ( {W}^{[ i ]} )}^{T} ,$$

$${WW}^{T} = {\sum }_{i ∈ K} {{W}^{[ i ]} ( {W}^{[ i ]} )}^{T} , and$$

$${1}^{T} {W}^{T} = {\sum }_{i ∈ K} {( {W}^{[ i ]} )}^{T} ,$$

and
denoting A₁ⁱ=\hat{τ}_{in,z}^{[i]}(W^{[i]})^{T}, and A₂ⁱ=W^{[i]}(W^{[i]})^{T}, the flow of a privacy-preserved calculation method for the sub-problem 2 being expressed as follows:
S31′: generating random matrices W^{[i]}, uᵢⱼ, pᵢⱼ, and q_{i,j} by the iₜₕ building region and sharing the same with all other building regions, collecting random matrices shared by the other building regions, and performing the following calculation:

$${\tilde{A}}_{1}^{i} = {A}_{1}^{i} + {\sum }_{j ∈ K , j > i} {u}_{i , j} - {\sum }_{j ∈ K , j < i} {u}_{j , i} ,$$

$${\tilde{A}}_{2}^{i} = {A}_{2}^{i} + {\sum }_{j ∈ K , j > i} {p}_{i , j} - {\sum }_{j ∈ K , j < i} {p}_{j , i} , and$$

$${\tilde{W}}^{[ i ]} = {W}^{[ i ]} + {\sum }_{j ∈ K , j > i} {q}_{i , j} - {\sum }_{j ∈ K , j < i} {q}_{j , i} ;$$

S32′: transferring Ã₁ⁱ, Ã₂ⁱ, and \tilde{W}^{[i]} to the building load aggregator by the iₜₕ building region;
S33′: calculating \hat{τ}_{in,z}W^{T}, WW^{T}, and 1^{T}W^{T} by the building load aggregator:

$${\hat{τ}}_{i n , z} {W}^{T} = {\sum }_{i ∈ K} {A}_{1}^{i} ,$$

$${1}^{T} {W}^{T} = {\sum }_{i ∈ K} {\tilde{W}}^{[ i ]} , and$$

$$W {W}^{T} = {\sum }_{i ∈ K} {A}_{2}^{i} ;$$

and
S34′: solving the sub-problem 2 by the building load aggregator.

Compared to the prior art, the present disclosure has the following beneficial effects: the present disclosure proposes the privacy-preserved method for constructing an aggregate thermal dynamic model of buildings, which helps a building load aggregator to estimate the model parameters of a building cluster while preserving privacy of the user (indoor temperature, cooling/heating power, etc.) from being leaked. By means of this method, the non-convex parameter estimation method for privacy preservation is investigated, the block coordinate descent method is employed to solve the non-convex problem, and the transformation-based encryption method and SAP are employed to realize the privacy preservation. The method is of certain pioneering significance with good computational accuracy and privacy-preserved performance.

### BRIEF DESCRIPTION OF THE DRAWINGS

FIG. 1 is a flow chart of steps of a privacy-preserved method for constructing an aggregate thermal dynamic model of buildings according to the present disclosure;

FIG. 2 is a schematic structural diagram of a building load aggregator-building cluster system to which Embodiment 2 of the present disclosure applies;

FIG. 3 is a comparison diagram of predicted values and real values of a building cluster in an aggregation state, and real indoor temperatures in various building regions in Embodiment 2 of the present disclosure; and

FIG. 4 is a comparison diagram of indoor temperature related information, before encryption and after encryption, of a building cluster in Embodiment 2 of the present disclosure.

### DETAILED DESCRIPTION

The present disclosure is further described below in combination with the accompanying drawings and specific implementations, and it is to be understood that the following specific implementations are intended merely to illustrate the present disclosure, rather than limiting the scope of the present disclosure.

### Embodiment 1

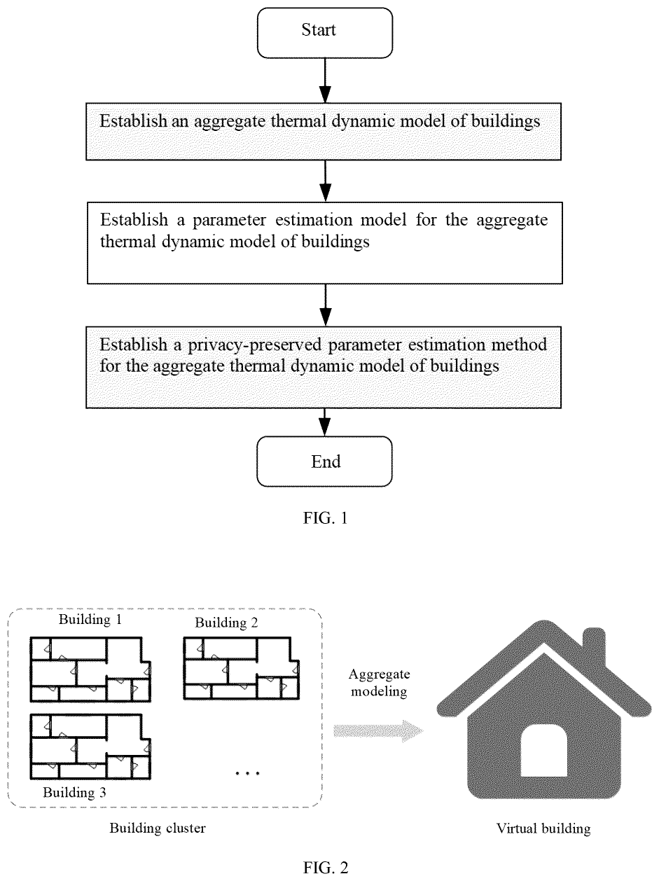

A privacy-preserved method for constructing an aggregate thermal dynamic model of buildings, applied in a building load aggregator-building cluster system, specifically includes the steps shown in FIG. 1.

In S1, an aggregate thermal dynamic model of buildings is established.

In S11, a thermal dynamic model of one building region is established:

$${τ}_{i n , z}^{t} = {\sum }_{m ∈ M ∖ \{ 0 \}} {α}_{z}^{m} {τ}_{i n , z}^{t - m} + {\sum }_{m ∈ M} {β}_{z}^{m} {h}_{load , z}^{t - m} + {\sum }_{m ∈ M} {γ}_{z}^{m} {τ}_{out}^{t - m} + {\sum }_{m ∈ M} {θ}_{z}^{m} {h}_{r a d}^{t - m} + {τ}_{occ}^{t} , ∀ t ∈ T$$

where τ_{in,z}^{t} represents an indoor temperature, h_{load,z}^{t} represent a thermal power, τₒᵤₜ^{t} represents an outdoor temperature, h_{rad}^{t} represents the solar radiant power, τ_{occ} serves to depict the role of occupants' activities, α_{z}^{m}, β_{z}^{m}, β_{z}^{m}, and θ_{z}^{m} represent parameters of the thermal dynamic model of the building region, and a set M={0,1, . . . , M} characterizes orders of the model.

In S12, an aggregation equation is established:

$${\tilde{τ}}_{i n , b c}^{t} = {\sum }_{i ∈ K} {ξ}_{b c}^{i} {τ}_{i n , z}^{i , t}$$

$$( {\sum }_{i ∈ K} {ξ}_{b c}^{i} = 1 , {ξ}_{b c}^{i} \geq 0 , ∀ i ∈ K )$$

where \tilde{τ}_{in,bc}^{t} represents an indoor temperature of a building cluster, ξ_{bc}ⁱ represents a aggregation coefficient of an iₜₕ building region, it is required to ensure that the sum of the aggregation coefficients of the building cluster is 1, and the aggregation coefficients are positive numbers; and a set K={1,2, . . . , K} represents various building regions.

In S13, an aggregate thermal dynamic model of buildings is established:

combining the thermal dynamic model of the building region established in step S11 with the aggregation equation established in step S12, the following aggregate thermal dynamic model of the building is obtained:

$${\tilde{τ}}_{i n , b c}^{c} = {\sum }_{m ∈ M ∖ \{ 0 \}} {α}_{b c}^{m} {\tilde{τ}}_{i n , bc}^{t - m} + {\sum }_{m ∈ M} {\sum }_{i ∈ K} {β}_{b c}^{m} {h}_{l o ad , z}^{i , t - m} + {\sum }_{m ∈ M} {γ}_{b c}^{m} {τ}_{out}^{t - m} + {\sum }_{m ∈ M} {θ}_{b c}^{m} {h}_{r a d}^{t - m} + {τ}_{o c c , bc}^{t} , ∀ t ∈ T$$

$$s . t . {\sum }_{i ∈ K} {ξ}_{b c}^{i} = 1 , {ξ}_{b c}^{i} \geq 0 , ∀ i ∈ K$$

where α_{bc}^{m}, β_{bc}^{m}, γ_{bc}^{m}, and θ_{bc}^{m} represent parameters of the aggregate thermal dynamic model of buildings.

In S2, a parameter estimation model for the aggregate thermal dynamic model of buildings is established.

In S21, a measurement equation is established:

$${\sum }_{i ∈ K} {ξ}_{b c}^{i} {τ}_{i n , z}^{i , t} = {\sum }_{m ∈ M ∖ \{ 0 \}} {\sum }_{i ∈ K} {α}_{b c}^{m} {ξ}_{b c}^{i} {τ}_{i n , z}^{i , t - m} + {\sum }_{m ∈ M} {\sum }_{i ∈ K} {β}_{b c}^{m} {h}_{l oad , z}^{i , t - m} + {\sum }_{m ∈ M} {γ}_{b c}^{m} {τ}_{out}^{t - m} + {\sum }_{m ∈ M} {θ}_{b c}^{m} {h}_{r a d}^{t - m} + {τ}_{occ , b c}^{t} + {ε}^{t} , ∀ t ∈ T$$

where ε^{t} represents an independently and identically distributed Gaussian noise.

In S22, a parameter estimation model for the aggregate thermal dynamic model of buildings is established:
based on the measurement equation established in step S21, parameter estimation is performed using a least square method, and a regular term is introduced to solve a sparsity problem of an aggregation coefficient. Defining

$$ξ = {[ {ξ}_{bc}^{1} , … , {ξ}_{bc}^{K} ]}^{T} , α = {[ {α}_{bc}^{1} , … , {α}_{bc}^{M} ]}^{T} , β = {[ {β}_{bc}^{0} , … , {β}_{bc}^{M} ]}^{T} ,$$

$$γ = {[ {γ}_{bc}^{0} , … , {γ}_{bc}^{M} ]}^{T} , θ = {[ {θ}_{bc}^{0} , … , {θ}_{bc}^{M} ]}^{T} , {τ}_{occ} = {[ {τ}_{occ}^{1} , … , {τ}_{occ}^{T} ]}^{T} ,$$

$${τ}_{out}^{- m} = {[ {τ}_{out}^{1 - m} , … , {τ}_{out}^{T - m} ]}^{T} , {h}_{rad}^{- m} = [ {h}_{rad}^{1 - m} , … {h}_{rad}^{T - m} ] ,$$

$${h}_{load , z}^{1 - m} = ( \begin{matrix}{h}_{load , z}^{1 , 1 - m} & … & {h}_{load , z}^{K , 1 - m} \\ ⋮ & ⋱ & ⋮ \\ {h}_{load , z}^{1 , T - m} & … & {h}_{load , z}^{K , T - m}\end{matrix} ) , {τ}_{i n , z}^{- m} = ( \begin{matrix}{τ}_{i n , z}^{1 , 1 - m} & … & {τ}_{i n , z}^{K , 1 - m} \\ ⋮ & ⋱ & ⋮ \\ {τ}_{i n , z}^{1 , T - m} & … & {τ}_{i n , z}^{K , T - m}\end{matrix} ) ,$$

the parameter estimation model in a compact form for the aggregate thermal dynamic model of buildings is obtained as follows:

$${min}_{ξ , α , β , γ , {τ}_{occ}} f ( ξ , α , β , γ , θ , {τ}_{o c c} ) = {‖ {c}_{0} ξ - {c}_{1} ( {I}_{M} ⊗ ξ ) α - {c}_{2} β - {c}_{3} γ - {c}_{4} θ - {τ}_{o c c} ‖}_{2}^{2} + λ {‖ ξ ‖}_{2}^{2} s . t . ξ \geq 0 , {1}^{T} ξ = 1$$

$$where , ξ = {[ {ξ}_{b c}^{1} , … , {ξ}_{b c}^{K} ]}^{T} , α = {[ {α}_{b c}^{1} , … , {α}_{b c}^{M} ]}^{T} ,$$

$$β = {[ {β}_{b c}^{0} , … , {β}_{b c}^{M} ]}^{T} , γ = {[ {γ}_{b c}^{0} , … , {γ}_{b c}^{M} ]}^{T} ,$$

$$θ = {[ {θ}_{b c}^{0} , … , {θ}_{b c}^{M} ]}^{T} , {τ}_{o c c} = {[ {τ}_{o c c}^{1} , … , {τ}_{o c c}^{T} ]}^{T} ,$$

$${τ}_{out}^{- m} = {[ {τ}_{out}^{1 - m} , … , {τ}_{out}^{T - m} ]}^{T} , {h}_{r a d}^{- m} = {[ {h}_{r a d}^{1 - m} , … , {h}_{r a d}^{T - m} ]}^{T} ,$$

$${h}_{load , z}^{1 - m} = ( \begin{matrix}{h}_{load , z}^{1 , 1 - m} & … & {h}_{load , z}^{K , 1 - m} \\ ⋮ & ⋱ & ⋮ \\ {h}_{load , z}^{1 , T - m} & … & {h}_{load , z}^{K , T - m}\end{matrix} ) , {τ}_{i n , z}^{- m} = ( \begin{matrix}{τ}_{i n , z}^{1 , 1 - m} & … & {τ}_{i n , z}^{K , 1 - m} \\ ⋮ & ⋱ & ⋮ \\ {τ}_{i n , z}^{1 , T - m} & … & {τ}_{i n , z}^{K , T - m}\end{matrix} ) ,$$

$${c}_{0} = {τ}_{i n , z}^{- 0} , {c}_{1} = [ {τ}_{i n , z}^{- 1} , … , {τ}_{i n , z}^{- M} ] , {c}_{2} = [ {h}_{l oad , z}^{- 0} {1}_{K} , … , {h}_{l oad , z}^{- M} {1}_{K} ] ,$$

$${c}_{3} = [ {τ}_{out}^{- 0} , … , {τ}_{out}^{- M} ] , and {c}_{4} = [ {h}_{r a d}^{- 0} , … , {h}_{r a d}^{- M} ] , {I}_{M}$$

represents an M dimensional I-vector, and ⊗ represents a Kronecker product.

In S3, a privacy-preserved parameter estimation method for an aggregate thermal dynamic model of buildings is established.

In S31, based on the iteration calculation of a block coordinate descent, ξ and α are fixed, respectively, the parameter estimation model for the aggregate thermal dynamic model of buildings established in step S2 is decomposed into two quadratic programming sub-problems, expressed by the following mathematical expressions:

$$S {P}_{I} ( ξ ) : {min}_{α , β , γ , θ , {τ}_{occ}} f ( ξ , α , β , γ , θ , {τ}_{o c c} ) , and$$

$$S {P}_{II} ( α ) : {min}_{ξ , β , γ , θ , {τ}_{occ}} f ( ξ , α , β , γ , θ , {τ}_{o c c} ) s . t . ξ \geq 0 , {1}^{T} ξ = 1.$$

In S32, a privacy-preserved calculation method for sub-problem 1 is provided.

Based on SAP, the flow of the privacy-preserved calculation method for the sub-problem 1 is designed as follows (all the building regions in steps (1)-(4) are required to be subjected to the calculation).
(1) ξᵢ is transferred to an iₜₕ building region by the building load aggregator.
(2) Sᵢ^{-m} is calculated by the iₜₕ building region according to Sᵢ^{-m}=ξᵢ(τ_{in,z}^{-m})^{[i]}, where (τ_{in,z}^{-m})^{[i]} represents an iₜₕ column of a matrix τ_{in,z}^{-m}.
(3) A random vector r_{i,j}^{-m} is generated by the iₜₕ building region and is shared with all other building regions, random vectors shared by the other building regions are collected, and the following calculation is performed:

$${\tilde{S}}_{i}^{- m} = {S}_{i}^{- m} + {\sum }_{j > i} {r}_{i , j}^{- m} - {\sum }_{j < i} {r}_{j , i}^{- m} .$$

(4) \tilde{S}ᵢ^{-m} is transferred by the iₜₕ building region to the building load aggregator.
(5) c₀ξ and c₁(I_{M}⊗ξ) are calculated by the building load aggregator:

$${c}_{0} ξ = {τ}_{i n , z}^{- 0} ξ = {\sum }_{i ∈ K} {S}_{i}^{- 0} = {\sum }_{i ∈ K} {\tilde{S}}_{i}^{- 0} , and$$

$${c}_{1} ( {I}_{M} ⊗ ξ ) = [ {τ}_{i n , z}^{- 1} ξ , … , {τ}_{i n , z}^{- M} ξ ] = [ {\sum }_{i ∈ K} {\tilde{S}}_{i}^{- 1} , … , {\sum }_{i ∈ K} {\tilde{S}}_{i}^{- M} ] .$$

(6) The sub-problem 1 is solved by the building load aggregator to obtain α(ξ), β(ξ), γ(ξ), θ(ξ), and τ_{occ}(ξ).

In S33, a privacy-preserved calculation method for sub-problem 2 is provided.

In the sub-problem 2, α is known, defining \hat{τ}_{in,z} [symbol] τ_{in,z}⁻⁰−Σ_{m∈M\{0}}α_{bc}^{m}τ_{in,z}^{-m}, and the sub-problem 2 is equivalently transformed into:

$$( f ( ξ , α , β , γ , θ , {τ}_{o c c} ) ) = {‖ {\hat{τ}}_{i n , z} ξ - {c}_{2} β - {c}_{3} γ - {c}_{4} θ - {τ}_{o c c} ‖}_{2}^{2} + λ {‖ ξ ‖}_{2}^{2}$$

$$s . t . ξ \geq 0 , {1}^{T} ξ = 1.$$

A random transformation matrix is introduced:

$$W = [ {W}^{[ 1 ]} … {W}^{[ K ]} ] = ( \begin{matrix}{w}_{11} & … & {w}_{1 K} \\ ⋮ & ⋱ & ⋮ \\ {w}_{K 1} & … & {w}_{KK}\end{matrix} ) .$$

The sub-problem 2 is further transformed into:

$${min}_{\overline{ξ} , β , γ , θ , {τ}_{occ}} f ( \overline{ξ} , β , γ , θ , {τ}_{occ} ) = {‖ {\hat{τ}}_{i n , z} {W}^{T} \overline{ξ} - {c}_{2} β - {c}_{3} γ - {c}_{4} θ - {τ}_{occ} ‖}_{2}^{2} + λ {\overline{ξ}}^{T} {WW}^{T} \overline{ξ}$$

$$s . t . {W}^{T} \overline{ξ} \geq 0 , {1}^{T} {W}^{T} \overline{ξ} = 1.$$

Denoting \hat{τ}_{in,z}^{[i] as an i}ₜₕ column of \hat{τ}_{in,z} the information required by the building load aggregator to solve the sub-problem 2 is \hat{τ}_{in,z}W^{T}, WW^{T}, and 1^{T}W^{T}, expressed in summation forms:

$${\hat{τ}}_{i n , z} {W}^{T} = {\sum }_{i ∈ K} {{\hat{τ}}_{i n , z}^{[ i ]} ( {W}^{[ i ]} )}^{T} ,$$

$$W {W}^{T} = {\sum }_{i ∈ K} {{W}^{[ i ]} ( {W}^{[ i ]} )}^{T} , and$$

$${1}^{T} {W}^{T} = {\sum }_{i ∈ K} {( {W}^{[ i ]} )}^{T} .$$

Denoting A₁ⁱ=\hat{τ}_{in,z}^{[i]}(W^{[i]})^{T}, and A₂ⁱ=W^{[i]}(W^{[i]})^{T}, based on SAP, the flow of the privacy-preserved calculation method for the sub-problem 2 is designed as follows.
(1) Random matrices W^{[i]}, u_{i,j}, p_{i,j}, and q_{i,j} are generated by the iₜₕ building region and are shared with all other building regions, random matrices shared by the other building regions are collected, and the following calculation is performed:

$${\tilde{A}}_{1}^{i} = {A}_{1}^{i} + {\sum }_{j ∈ K , j > i} {u}_{i , j} - {\sum }_{j ∈ K , j < i} {u}_{j , i} ,$$

$${\tilde{A}}_{2}^{i} = {A}_{2}^{i} + {\sum }_{j ∈ K , j > i} {p}_{i , j} - {\sum }_{j ∈ K , j < i} {p}_{j , i} , and$$

$${\tilde{W}}^{[ i ]} = {W}^{[ i ]} + {\sum }_{j ∈ K , j > i} {q}_{i , j} - {\sum }_{j ∈ K j < i} {q}_{j , i} .$$

(2) Ã₁ⁱ, Ã₂ⁱ, and \tilde{W}^{[i]} are transferred to the building load aggregator by the iₜₕ building region.
(3) \hat{τ}_{in,z}W^{T}, WW^{T}, and 1^{T}W^{T} are calculated by the building load aggregator:

$${\hat{τ}}_{i n , z} {W}^{T} = {\sum }_{i ∈ K} {A}_{1}^{i} ,$$

$${1}^{T} {W}^{T} = {\sum }_{i ∈ K} {\tilde{W}}^{[ i ]} , and$$

$$W {W}^{T} = {\sum }_{i ∈ K} {A}_{2}^{i} .$$

(4) The sub-problem 2 is solved by the building load aggregator.

In this embodiment, the overall flow of the privacy-preserved parameter estimation method for the aggregate thermal dynamic model of buildings is as follows: the building load aggregator sets the initial value of the iteration, sets δ<10⁻⁶ as an iteration termination condition for the difference value 8 between objective functions of the sub-problem 1 and the sub-problem 2, and sequentially repeats the privacy-preserved calculation method of the sub-problem 1 in S32 and the sub-problem 2 in S33 until the iteration converges.

### Embodiment 2

A building load aggregator-building cluster system in this embodiment is formed by a building load aggregator and seven buildings (including a total of 64 building regions), and the aggregator performs aggregate modeling of the seven buildings, as shown schematically in FIG. 2. The total number of simulation data is 1440, of which, 1080 pieces of data are training sets, and the remaining 360 pieces of data are test sets. The simulation time interval is set to 30 minutes, the occupants' activity period is 24 hours, a random matrix follows a normal distribution with a mean of 0.1 and a standard deviation of 0.1, and an order M of the aggregate thermal dynamic model is set to 2, and the penalty coefficient λ is set to 100.

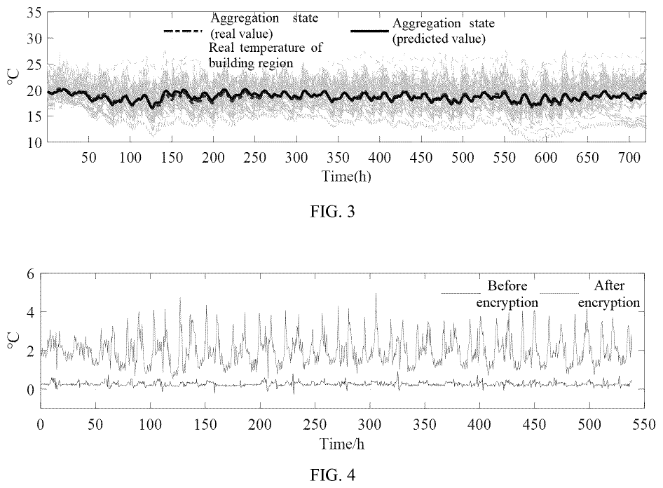

A parameter estimation model is solved for a privacy-preserved aggregate thermal dynamic model according to the steps of the present disclosure. FIG. 3 is a comparison diagram of predicted values and real values of a building cluster in the aggregation state as well as real indoor temperatures of various building regions in Embodiment 2; and FIG. 4 is a comparison diagram of indoor temperature related information, before encryption and after encryption, of a region of the building cluster in Embodiment 2. As seen in FIG. 3, the predicted values in the aggregation state are very close to the real values, indicating that the model prediction is accurate. As seen in FIG. 4, the difference between the private information before and after encryption is very large and irregular, indicating that the encryption effect is good. Thus, the parameter estimation model for the privacy-preserved aggregate thermal dynamic model of the present disclosure is high in accuracy and good in prediction effect, and can effectively preserve the user's privacy information from being leaked.

The description of reference terms “an embodiment”, “an example”, “a specific example” throughout the specification means that a particular feature, structure, material, or characteristic described in connection with the embodiment or example is included in at least one embodiment or example of the present disclosure. In the specification, an indicative expression of the above terms not necessarily refers to the same embodiment or example. Furthermore, the particular feature, structure, material, or characteristic described may be combined in any suitable manner in any one or more embodiments or examples.

It is to be noted that the above content only illustrates the technical ideas of the present disclosure, cannot be used to limit the scope of protection of the present disclosure. For those ordinary skilled in the art, without departing from the principle of the present disclosure, a number of improvements and modifications can be made, and these improvements and modifications fall into the scope of protection of the claims of the present disclosure.

1. A privacy-preserved method for constructing an aggregate thermal dynamic model of buildings, comprising: establishing an aggregate thermal dynamic model of buildings and its corresponding parameter estimation model; dividing, according to a block coordinate descent theory, an original non-convex parameter estimation problem into two convex optimization problems for iterative solution, and realizing the privacy preservation of user's information according to a transformation-based encryption method and a secure aggregation protocol (SAP).

2. The privacy-preserved method for constructing an aggregate thermal dynamic model of buildings according to claim 1, comprising the following steps:
S1, establishing an aggregate thermal dynamic model of buildings: establishing a thermal dynamic model of one building region, and establishing an aggregate thermal dynamic model of buildings based on an aggregation equation:
$${\tilde{τ}}_{i n , b c}^{t} = {\sum }_{m ∈ M ∖ \{ 0 \}} {α}_{b c}^{m} {\tilde{τ}}_{i n , bc}^{t - m} + {\sum }_{m ∈ M} {\sum }_{i ∈ K} {β}_{b c}^{m} {h}_{l oad , z}^{i , t - m} + {\sum }_{m ∈ M} {γ}_{b c}^{m} {τ}_{out}^{t - m} + {\sum }_{m ∈ M} {θ}_{b c}^{m} {h}_{r a d}^{t - m} + {τ}_{o c c , bc}^{t} ,$$
$$∀ t ∈ T$$
$$s . t . {\sum }_{i ∈ K} {ξ}_{b c}^{i} = 1 , {ξ}_{b c}^{i} \geq 0 , ∀ i ∈ K$$
where \tilde{τ}_{in,bc}^{t} represents an aggregated indoor temperature of a building cluster, h_{load,z}^{i,t-m} represents a thermal power of a sub-region i at a moment t-m, τₒᵤₜ^{t-m} represents 1 an outdoor temperature at the moment t-m, h_{rad}^{t-m} represents a solar radiant power at the moment t-m, τ_{occ,bc}^{t} serves to depict the role of occupants' activities, ξ_{bc}ⁱ represents an aggregation coefficient of an iₜₕ building region, a set K={1, 2, . . . , K} represents various building regions, and α_{bc}^{m}, β_{bc}^{m}, γ_{bc}^{m}, and θ_{bc}^{m} represent parameters of the aggregate thermal dynamic model of buildings;
S2, establishing a parameter estimation model for the aggregate thermal dynamic model of buildings: performing parameter estimation using a least square method based on a measurement equation, and introducing a regular term to solve a sparsity problem of an aggregation coefficient, to obtain the parameter estimation model in a compact form for the aggregate thermal dynamic model of buildings:
$${min}_{ξ , β , γ , θ , {τ}_{occ}} f ( ξ , α , β , γ , θ , {τ}_{o c c} ) = {‖ {c}_{0} ξ - {c}_{1} ( {I}_{M} ⊗ ξ ) α - {c}_{2} β - {c}_{3} γ - {c}_{4} θ - {τ}_{occ} ‖}_{2}^{2} + λ {‖ ξ ‖}_{2}^{2}$$
$$s . t . ξ \geq 0 , {1}^{T} ξ = 1$$
$$where ξ = {[ {ξ}_{bc}^{1} , … , {ξ}_{bc}^{K} ]}^{T} , α = {[ {α}_{bc}^{1} , … , {α}_{bc}^{M} ]}^{T} , β = {[ {β}_{bc}^{0} , … , {β}_{bc}^{M} ]}^{T} ,$$
$$γ = {[ {γ}_{bc}^{0} , … , {γ}_{bc}^{M} ]}^{T} , θ = {[ {θ}_{bc}^{0} , … , {θ}_{bc}^{M} ]}^{T} , {τ}_{occ} = {[ {τ}_{occ}^{1} , … , {τ}_{occ}^{T} ]}^{T} ,$$
$${τ}_{out}^{- m} = {[ {τ}_{out}^{1 - m} , … , {τ}_{out}^{T - m} ]}^{T} , {h}_{rad}^{- m} = {[ {h}_{rad}^{1 - m} , … , {h}_{rad}^{T - m} ]}^{T} ,$$
$${h}_{load , z}^{1 - m} = ( \begin{matrix}{h}_{load , z}^{1 , 1 - m} & … & {h}_{load , z}^{K , 1 - m} \\ ⋮ & ⋱ & ⋮ \\ {h}_{load , z}^{1 , T - m} & … & {h}_{load , z}^{K , T - m}\end{matrix} ) , {τ}_{i n , z}^{- m} = ( \begin{matrix}{τ}_{i n , z}^{1 , 1 - m} & … & {τ}_{i n , z}^{K , 1 - m} \\ ⋮ & ⋱ & ⋮ \\ {τ}_{i n , z}^{1 , T - m} & … & {τ}_{i n , z}^{K , T - m}\end{matrix} ) , {c}_{0} = {τ}_{i n , z}^{0} ,$$
$${c}_{1} = [ {τ}_{i n , z}^{- 1} , … , {τ}_{i n , z}^{- M} ] , {c}_{2} = [ {h}_{load , z}^{- 0} {1}_{k} , … , {h}_{load , z}^{- M} {1}_{k} ] ,$$
$${c}_{3} = [ {τ}_{out}^{- 0} , … , {τ}_{out}^{- M} ] , and {c}_{4} = [ {h}_{rad}^{- 0} , … , {h}_{rad}^{- M} ] ,$$
I_{M} represents an M dimensional I-vector, and ⊗ represents a Kronecker product; and
S3, establishing a privacy-preserved parameter estimation method for the aggregate thermal dynamic model of buildings: decomposing the parameter estimation model for the aggregate thermal dynamic model of buildings established in step S2 into two quadratic programming sub-problems expressed by the following mathematical expressions:
$$S {P}_{I} ( ξ ) : {min}_{a , β , γ , θ , {τ}_{occ}} f ( ξ , α , β , γ , θ , {τ}_{o c c} )$$
$$S {P}_{I I} ( α ) : {min}_{ξ , β , γ , θ , {τ}_{occ}} f ( ξ , α , β , γ , θ , {τ}_{o c c} ) s . t . ξ \geq 0 , {1}^{T} ξ = 1 ,$$
for sub-problem 1, completing a privacy-preserved calculation by a building load aggregator based on SAP, and solving the sub-problem 1 to obtain α(ξ), β(ξ), γ(ξ), θ(ξ), and τ_{occ}(ξ); for sub-problem 2, introducing a random transformation matrix by the building load aggregator, completing a privacy-preserved calculation based on SAP, and solving the sub-problem 2 to obtain ξ(α), β(α), γ(α), (α), and τ_{occ}(α); setting an initial value of iteration by the building load aggregator, setting δ<10⁻⁶ as an iteration termination condition for a difference value 8 between objective functions of the sub-problem 1 and the sub-problem 2, and sequentially repeating the privacy-preserved calculation of the sub-problem 1 and the sub-problem 2 until the iteration converges.

3. The privacy-preserved method for constructing an aggregate thermal dynamic model of buildings according to claim 2, wherein in step S1, the thermal dynamic model of the building region is specified as:
$${τ}_{i n , z}^{t} = {\sum }_{m ∈ M ∖ \{ 0 \}} {α}_{z}^{m} {τ}_{i n , z}^{t - m} + {\sum }_{m ∈ M} {β}_{z}^{m} {h}_{l o a d , z}^{t - m} + {\sum }_{m ∈ M} {γ}_{z}^{m} {τ}_{out}^{t - m} + {\sum }_{m ∈ M} {θ}_{z}^{m} {h}_{r a d}^{t - m} + {τ}_{occ}^{c} ,$$
$$∀ t ∈ T$$
where τ_{in,z}^{-m} represents an indoor temperature, α_{z}^{m}, β_{z}^{m}, γ₂^{m}, and of represent parameters of the thermal dynamic model of the building region, and a set M={0,1, . . . , M} characterizes orders of the model; and
the aggregation equation is specified as:
$${\tilde{τ}}_{i n , b c}^{t} = {\sum }_{i ∈ K} {ξ}_{b c}^{i} {τ}_{i n , z}^{i , t}$$
$$( {\sum }_{i ∈ K} {ξ}_{b c}^{i} = 1 , {ξ}_{b c}^{i} \geq 0 , ∀ i ∈ K )$$
where τ_{in,z}^{i,t} represents an indoor temperature of a building region i at a moment t.

4. The privacy-preserved method for constructing an aggregate thermal dynamic model of buildings according to claim 2, wherein the measurement equation in step S2 is specified as
$${\sum }_{i ∈ K} {ξ}_{b c}^{i} {τ}_{i n , z}^{t} = {\sum }_{m ∈ M \backslash \{ 0 \}} {\sum }_{i ∈ K} {α}_{bc}^{m} {ξ}_{bc}^{i} {τ}_{i n , z}^{i , t - m} + {\sum }_{m ∈ M} {\sum }_{i ∈ K} {β}_{bc}^{m} {h}_{l o a d , z}^{i , t - m} + {\sum }_{m ∈ M} {γ}_{bc}^{m} {τ}_{out}^{t - m} + {\sum }_{m ∈ M} {θ}_{bc}^{m} {h}_{r a d}^{t - m} + {τ}_{occ , bc}^{t} + {ε}^{t} ,$$
$$∀ t ∈ T$$
where ε^{t} represents an independently and identically distributed Gaussian noise.

5. The privacy-preserved method for constructing an aggregate thermal dynamic model of buildings according to claim 2, wherein in step S3, the flow of a privacy-preserved calculation method for the sub-problem 1 is as follows:
S31: transferring ξᵢ by the building load aggregator to an iₜₕ building region;
S32: calculating Sᵢ^{-m} by the iₜₕ building region according to Sᵢ^{-m}=ξᵢ(τ_{in,z}^{-m}), where (τ_{in,z}^{-m})^{[i]} represents an iₜₕ column of a matrix τ_{in,z}^{-m};
S33: generating a random vector r_{i,j}^{-m} by the iₜₕ building region and sharing the same with all other building regions, collecting random vectors shared by the other building regions, and performing the following calculation:
$${\tilde{S}}_{i}^{- m} = {S}_{i}^{- m} + {\sum }_{j > i} {r}_{i , j}^{- m} - {\sum }_{j < i} {r}_{j , i}^{- m} ;$$
S34: transferring \tilde{S}ᵢ^{-m} by the iₜₕ building region to the building load aggregator;
S35: calculating c₀ξ and c₁(I_{M}⊗ξ) by the building load aggregator:
$${c}_{0} ξ = {τ}_{i n , z}^{- 0} ξ = {\sum }_{i ∈ K} {S}_{i}^{- 0} = {\sum }_{i ∈ K} {\tilde{S}}_{i}^{- 0} , and$$
$${c}_{1} ( {I}_{M} ⊗ ξ ) = [ {τ}_{i n , z}^{- 1} ξ , … , {τ}_{i n , z}^{- M} ξ ] = [ {\sum }_{i ∈ K} {\tilde{S}}_{i}^{- 1} , … , {\sum }_{i ∈ K} {\tilde{S}}_{i}^{- M} ] ;$$
and
S36: solving the sub-problem 1 by the building load aggregator to obtain α(ξ), β(ξ), γ(ξ), θ(ξ), and τ_{occ}(ξ).

6. The privacy-preserved method for constructing an aggregate thermal dynamic model of buildings according to claim 2, wherein in step S3, the random transformation matrix is introduced to further transform the sub-problem 2 into:
$${min}_{\overline{ξ} , β , γ , θ , {τ}_{occ}} f ( \overline{ξ} , β , γ , θ , {τ}_{occ} ) = {‖ {\hat{τ}}_{i n , z} {W}^{T} \overline{ξ} - {c}_{2} β - {c}_{3} γ - {c}_{4} θ - {τ}_{occ} ‖}_{2}^{2} + λ {\overline{ξ}}^{T} W {W}^{T} \overline{ξ}$$
$$s . t . {W}^{T} \overline{ξ} \geq 0 , {1}^{T} {W}^{T} \overline{ξ} = 1 ,$$
denoting \hat{τ}_{in,z}^{[i]} as an iₜₕ column of \hat{τ}_{in,z}, the information required by the building load aggregator to solve the sub-problem 2 being \hat{τ}_{in,z}W^{T}, WW^{T}, and 1^{T}W^{T}, expressed in summation forms, respectively:
$${\hat{τ}}_{i n , z} {W}^{T} = {\sum }_{i ∈ K} {{\hat{τ}}_{i n , z}^{[ i ]} ( {W}^{[ i ]} )}^{T} ,$$
$$W {W}^{T} = {\sum }_{i ∈ K} {{W}^{[ i ]} ( {W}^{[ i ]} )}^{T} , and$$
$${1}^{T} {W}^{T} = {\sum }_{i ∈ K} {( {W}^{[ i ]} )}^{T} ,$$
and
denoting A₁ⁱ=τ_{in,z}^{[i]}(W^{[i]})^{T}, and A₂ⁱ=W^{[i]}(W^{[i]})^{T}, the flow of a privacy-preserved calculation method for the sub-problem 2 being expressed as follows:
S31′: generating random matrices W^{[i]}, u_{i,j}, p_{i,j}, and q_{i,j} by the iₜₕ building region and sharing the same with all other building regions, collecting random matrices shared by the other building regions, and performing the following calculation:
$${\tilde{A}}_{1}^{i} = {A}_{1}^{i} + {\sum }_{j ∈ K j > i} {u}_{i , j} - {\sum }_{j ∈ K j < i} {u}_{j , i} ,$$
$${\tilde{A}}_{2}^{i} = {A}_{2}^{i} + {\sum }_{j ∈ K , j > i} {p}_{i , j} - {\sum }_{j ∈ K , j < i} {p}_{j , i} , and$$
$${\tilde{W}}^{[ i ]} = {W}^{[ i ]} + {\sum }_{j ∈ K j > i} {q}_{i , j} - {\sum }_{j ∈ K j < i} {q}_{j , i} ;$$
S32′: transferring Ã₁ⁱ, Ã₂ⁱ, and \tilde{W}^{[i]} to the building load aggregator by the iₜₕ building region;
S33′: calculating \hat{τ}_{in,z}W^{T}, WW^{T}, and 1^{T}W^{T} by the building load aggregator:
$${\hat{τ}}_{i n , z} {W}^{T} = {\sum }_{i ∈ K} {A}_{1}^{i} ,$$
$${1}^{T} {W}^{T} = {\sum }_{i ∈ K} {\tilde{W}}^{[ i ]} , and$$
$$W {W}^{T} = {\sum }_{i ∈ K} {A}_{2}^{i} ,$$
and
S34′: solving the sub-problem 2 by the building load aggregator.
